(19) United States
(12) Patent Application Publication
(10) Pub. No.: US 2024/0223385 A1
(43) Pub. Date: Jul. 4, 2024

(54) METHOD AND APPARATUS FOR DEVICE AUTHENTICATION USING CHAINS OF CERTIFICATES

(71) Applicant: SIERRA WIRELESS, INC., Richmond (CA)

(72) Inventor: Alex JIANG, Surrey (CA)

(73) Assignee: SIERRA WIRELESS, INC., Richmond, BC (CA)

(21) Appl. No.: 18/090,314

(22) Filed: Dec. 28, 2022

(51) Int. Cl. H04L 9/32

(52) U.S. Cl. CPC H04L 9/3268; H04L 9/3247

(57) ABSTRACT

Chains of cryptographic certificates are used for server authentication in a recursive manner. A device requires a Root certificate to authenticate a server, where the Root certificate is changed periodically. Each Root certificate is signed using a prior Root certificate. When a device is required to perform an authentication, multiple Root certificates forming a chain are provided to the device. The device authenticates the first Root certificate in the chain using a previously stored Root certificate, and authenticates each other Root certificate in the chain using a prior Root certificate in the chain. Upon authenticating the last Root certificate in the chain, the authentication can be completed. An associated server is also provided. The device can store the last Root certificate in the chain for use in defining subsequent chains.

### FIELD

The present invention pertains to the field of communications security, and in particular to methods and apparatuses for authenticating devices using cryptographic certificates.

### BACKGROUND

Datagram Transport Layer Security (DTLS) is a protocol by which datagram-based communications can be performed securely. DTLS is similar to the Transport Layer Security (TLS) protocol, and potentially achieves a lower latency and lower overhead, but at the expense of some features such as guaranteed order-of-delivery of messages and packet loss mitigation.

DTLS can provide secure communication over the Internet and includes features to support authentication, confidentiality and integrity. When a DTLS connection is established between client and server, the server provides a server certificate, which the client verifies before trusting the server's identity. The server certificate is verified using a certificate associated with a Certificate Authority (CA) that issued the server certificate. Conventionally, the CA certificate, called the Root certificate, is trusted because the client was provisioned with it using a trusted but out-of-band mechanism.

When a device acts as a DTLS client and connects to a server, the device authenticates the server with the Root certificate as stored in the device. The initial Root certificate is typically provisioned into the device during the manufacturing process. Updating the Root certificate in the field may be done using a cross-signing process, in which the original certificate signs the new certificate. However, this approach, as traditionally performed, only works if the device connects to the server before the original Root certificate expires.

Some devices, such as Internet of Things (IOT) devices, are often offline (and thus disconnected from server) and may stay offline for extended periods of time. This means that the above-mentioned Root certificate updating process can only be performed infrequently because the operator must ensure that all dependent devices are updated with the new certificate before the old certificate expires, and thus Root certificates in such situations are typically in place for long periods of time. This long time period increases the risk of a certificate compromise, for example due to brute-force or other forms of attacks. Timely certificate rotations or renewals using short-lived certificates is an effective means of reducing security risks. However, such rotations or renewals are typically not employed in IoT systems because of the challenges to certificate updating which is posed by the IoT devices being offline for extended periods of time.

Accordingly, there is a need for methods, systems and devices, that are not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and devices for device authentication using chains of certificates, such as Root certificates. Temporal certificate chains can be used for example to improve the security and/or efficiency of IoT systems where devices connect to servers using DTLS (or other transport protocols) and authentication of the server is required. Each certificate in a chain may be signed using the private key of the previous certificate in the chain. Authentication may be performed starting with a most recently stored certificate and proceed sequentially along the chain up to the latest certificate in the chain. Limited or minimal chains may be sent to devices so that they can be authenticated and updated in the device, by having the device report its most recently stored certificate, and only sending the device subsequent certificates. More generally, temporal certificate chains may be useful in a setting where a relying party needs to authenticate an opposing party using a certificate that is stored locally, and the locally stored certificate is remotely rotated. Embodiments may be particularly useful when the relying party is potentially offline for extended periods.

According to an aspect of the present disclosure, there is provided an electronic device (also referred to as an end device), such as a client device or IoT device, having a communication interface, a memory, and processing electronics. The communication interface is configured to communicate directly or indirectly with a server. The memory is initially configured to store a prior Root certificate. The processing electronics are configured, to cause the electronic device to operate as follows, at least in some instances. It is to be readily understood that in other instances, the device may receive zero or one Root certificate from the server and may in those instances respond differently. In response to the electronic device receiving, from the server (via the communication interface) two or more additional Root certificates, the device authenticates a first one of the additional Root certificates using the prior Root certificate. After authenticating the first one of the additional Root certificates, the device sequentially authenticates each one of the additional Root certificates, other than the first one of the additional Root certificates, using another one of the additional Root certificates which is already authenticated. Thus the Root certificates form a chain and is authenticated as such. After authenticating each one of the additional Root certificates, the prior Root certificate is updated in memory to be a most recent one of the additional Root certificates.

According to an aspect of the present disclosure, there is provided an electronic device including a communication interface configured to communicate directly or indirectly with a server and a memory configured to store a prior root certificate. The electronic device further including processing electronics configured to send, to the server via the communication interface, an indication of the prior root certificate and receive, from the server via the communication interface, a number of additional root certificates. Upon determination that the number of additional certificates is zero, the processing electronics further configured to authenticate the server using the prior root certificate. Upon determination that the number of additional certificates is one or more, the processing electronics further configured to authenticate the server using the prior root certificate and the one or more of the additional root certifications and replace the prior root certificate with a most recent additional root certificate.

In some embodiments, the device is further configured to authenticate a server certificate indicative of an identity of the server using the most recent one of the additional Root certificates. The server certificate can be received by the device along with the Root certificates.

In some embodiments, the device is further configured, prior to receiving the two or more additional Root certificates, to send an indication of the prior Root certificate to the server via the communication interface. This allows the server to determine whether the device's prior Root certificate is up-to-date, and/or to determine which Root certificates to send to the device to bring it up-to-date.

In some embodiments, the prior Root certificate is retained in the memory until the updating in the memory of the prior Root certificate to be the most recent one of the additional Root certificates. In some embodiments, the electronic device receives or determines an indication of ordering of the two or more additional Root certificates, and the sequentially authenticating is performed according to said ordering.

In some embodiments, the electronic device receives one or more invalid Root certificates which occur, according to the ordering, after the most recent one of the additional Root certificates. The device is then configured to determine that the one or more invalid Root certificates cannot be authenticated using the most recent one of the additional Root certificates; and subsequently discard the one or more invalid Root certificates.

In some embodiments, the two or more additional Root certificates are received by the electronic device prior to the electronic device authenticating the first one of the additional Root certificates, authenticating some or all of the additional Root certificates, or a combination thereof. In some embodiments, the two or more additional Root certificates are received in response to a same single message from the electronic device.

In various embodiments, authenticating of any one of the additional Root certificates comprises determining that said one of the additional Root certificates is signed using (e.g. signed with or signed by) a private cryptographic key associated with another Root certificate which is either: initially provisioned to the electronic device; or previously authenticated by the electronic device.

According to another aspect of the present disclosure, there is provided an electronic server device (also referred to as a server) having one or more communication interfaces configured to communicate directly or indirectly with a client device and with a certificate authority, a memory, and processing electronics. The processing electronics are configured, to cause the electronic server device to operate as follows, at least in some instances. The server device stores, in memory, a plurality of Root certificates along with an indication of ordering of the plurality of Root certificates. The plurality of Root certificates are received (via a communication interface) from the certificate authority. Each one of the plurality of Root certificates is signed using a private cryptographic key associated with a previous one of the plurality of Root certificates according to the ordering. Thus the Root certificates are cross-signed and form a chain. In response to the server device receiving, from the client device, at least one message including a message indicating a particular Root certificate, the server device sends, to the client device, two or more Root certificates of the plurality of Root certificates. A first one of the two or more Root certificates is signed using a private cryptographic key of the particular Root certificate. Each other one of the two or more Root certificates is signed using a private cryptographic key of another one of the two or more Root certificates.

In some embodiment, the received previous one of the plurality of Root certificates is an immediately previous one of the plurality of Root certificates according to the ordering. The server determines the first Root certificate in the sent two or more Root certificates as the Root certificate occurring in the chain immediately after this received previous one of the Root certificates.

In some embodiments, the particular Root certificate is one of the plurality of Root certificates or immediately precedes the plurality of Root certificates according to the ordering. In some further embodiments, the two or more Root certificates immediately follow the particular Root certificate according to the ordering and are a contiguous subset of the plurality of Root certificates according to the ordering. In some embodiments, the particular Root certificate is a most recent Root certificate held by the client device. In some embodiments, the two or more Root certificates are sent to the client device, in one or more messages, in response to a same single message from the client device. In some embodiments, the server implicitly or explicitly indicates, to the client device, the ordering among the two or more Root certificates.

According to another aspect of the present disclosure, there is provided a method comprising, by an electronic device having a prior Root certificate stored in memory, performing actions in response to receiving, from a server, two or more additional Root certificates, at least in some instances. The actions include authenticating a first one of the additional Root certificates using the prior Root certificate. The actions include, after authenticating the first one of the additional Root certificates: sequentially authenticating each one of the additional Root certificates other than the first one of the additional Root certificates using another one of the additional Root certificates which is already authenticated. The actions include, after authenticating each one of the additional Root certificates: updating, in the memory, the prior Root certificate to be a most recent one of the additional Root certificates. The method can include further features, similar to those of the electronic device as described above.

According to another aspect of the present disclosure, there is provided a method comprising, by an electronic server device, a set of actions, at least in some instances. The actions include storing, in memory, a plurality of Root certificates along with an indication of ordering of the plurality of Root certificates. The plurality of Root certificates are received from a certificate authority. Each one of the plurality of Root certificates is signed using a private cryptographic key associated with a previous one of the plurality of Root certificates according to the ordering. The actions include, in response to the server device receiving, from a client device, at least one message including a message indicating a particular Root certificate: sending, to the client device, two or more Root certificates of the plurality of Root certificates. A first Root certificate of the two or more Root certificates is signed using a private cryptographic key of the particular Root certificate. Each one of the two or more Root certificates other than the first Root certificate is signed using a private cryptographic key of another one of the two or more Root certificates. The method can include further features, similar to those of the electronic server device as described above.

Various embodiments provide for a system including at least one electronic server device and at least one electronic client device, as described above. At least one electronic server of a certificate authority may also be provided. Methods corresponding to such a system may also be provided. Computer program products including stored, in non-transitory memory, statements and instructions for performing one or more methods as described above may also be provided.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a system including a server and a set of end devices, according to embodiments of the present disclosure.

FIG. 2 illustrates operations of an end device, according to embodiments of the present disclosure.

FIG. 3 illustrates operations of a server, according to embodiments of the present disclosure.

FIGS. 4A and 4B illustrate operations of various system components together, according to embodiments of the present disclosure.

FIG. 5 illustrates an electronic device according to embodiments of the present disclosure.

It will be noted that throughout the appended drawings, like features are identified by like reference numerals.

### DETAILED DESCRIPTION

As used herein, the term “Root certificate” refers to a cryptographic certificate which is already trusted or which may be authenticated so as to be trusted. A Root certificate may be stored as data in a device's memory. An original Root certificate, provisioned in a device at manufacture or initial deployment in a secure environment, may be self-signed. An existing Root certificate stored in a device may be replaced by a new Root certificate if the new Root certificate is authenticated (so that it is also securely provided). One way of securely providing the new Root certificate involves having the new Root certificate be signed using the existing Root certificate, and then authenticating the signature. Thus, Root certificates are not necessarily self-signed. A Root certificate can also be referred to simply as a “certificate,” while “certificate” may also be used more generally. To avoid ambiguity, a “server certificate” is consistently referred to as such.

In various embodiments, a Root certificate is a certificate issued by a CA and which is at the bottom of a public key infrastructure (PKI) hierarchy. A typical certificate verification path is from the server certificate, to zero or more intermediate certificates, to a Root certificate. Temporal chains may provide an orthogonal verification path from one root to another in time.

In various embodiments, a server certificate is time limited, so that the server is required to obtain a new server certificate from the CA before its current certificate expires, to avoid an interruption in service. Generally, the new server certificate will have a new public key and a new corresponding private key. The validity period of the new server certificate will also be updated. A CA may also issue certificates to multiple servers. Each server certificate will then contain the specific server's identity, such as the server's fully qualified domain name (FQDN).

Replacing the existing Root certificate in a device with the new Root certificate can involve updating, in memory (e.g. persistent or non-persistent memory), the existing Root certificate to be the new Root certificate, either by overwriting the memory location, adjusting pointers to point to the new Root certificate instead of the existing Root certificate, or the like.

Signing a certificate (or message) with a private cryptographic key, can include, for example, creating a hash of the certificate (or message), encrypting the hash using the private key, and providing the result of the encryption along with (e.g. as part of) the certificate (or message). A corresponding public key can be used to decrypt the provided result of encryption, which can then be compared against the hash. The hash may be generated from the certificate (or message). A match resulting from the comparison proves that the certificate (or message) was signed with the private key, thus authenticating the certificate (or message) provider. Further details and variations will be readily understood by a person skilled in the art. The term “key” and “cryptographic key” are used interchangeably herein.

Embodiments of the disclosure provide for a method, system and apparatus for device authentication using chains of cryptographic certificates, such as Root certificates. Such chains may be referred to as certificate temporal chains, in which each certificate in the chain is used to sign the next certificate in the chain, thus providing a way to authenticate each certificate based on the authenticity of its predecessor, which in turn is authenticated based on its predecessor, and so on. Certificate temporal chains use a form of cross-signing (referred to herein as forward-signing) in which the private key of a certificate is used to sign a new (updated) certificate for the same entity. This forward signing is repeated each time a new certificate is generated, thereby building a chain of certificates over time. These temporal certificate chains may be used to provide forward authentication in time, in which certificates are updated and but not downgraded (or reverted).

A CA can build temporal chains for its own Root certificates, and this may be used to ease the Root certificate rotations for dependent devices, as described below. This approach allows Root certificates to be rotated (changed) at a desired rate or frequency even when dependent devices (e.g. IoT client devices) are offline for extended periods of time. Accordingly, even when a dependent device is expected to be offline for a given time period, the associated Root certificate can be changed several times over that time period.

The term “offline” may generally refer to a state in which a device is not receiving communications or updates at least regarding certificates such as Root certificates. This may be the result of a low-power mode, a radio or device power down operation, time spent disconnected from or out-of-range of a communication network, etc. When not offline, a device may be connected to a server via a wired or wireless communication network, or other type of communication link or series of links. A server can serve multiple devices.

According to embodiments, when a device comes online after a potentially long period of being offline, a temporal certificate chain is sent to the device. In various embodiments, the device initiates contact with a server, and the server responds by determining and sending the temporal certificate chain to the device. Furthermore, in embodiments, the server may send the temporal certificate chain in-band during the connection handshake. In various embodiments, the device may send a single message to the server, and the server may send the temporal certificate chain (of multiple Root certificates) in response to this same single message from the device.

In various embodiments, the beginning of the certificate chain may depend on the most recent certificate already held by the device. This reduces the amount of data required to be sent compared to an alternative (but possible) embodiment in which the server sends the entire certificate chain from a designated beginning of time, each time a device connects to the server. In order to define the beginning of the certificate chain, the device, upon contacting the server, informs the server of the most recent (and possibly only relevant) certificate which it has stored. In various embodiments, the device may use a standard TLS extension called trusted_ca_keys to inform the server of the current Root certificate held by the device. The device may thus provide an indication, to the server, of its currently held Root certificate.

Based on the information about the current Root certificate, the server determines the appropriate certificate chain (which may be referred to as a sub-chain of an overall chain) to send to the device. The certificate chain begins with the Root certificate immediately following the certificate specified by the device, and may end with the most recent Root certificate held at the server. The certificate chain may include one Root certificate in some cases, or two, three or more Root certificates. The certificate chain may include zero Root certificates, for example when the device already possesses the most recent Root certificate.

The server may then send all of the certificates in the chain to the device, either in one (potentially long) message or in a series of messages. According to this approach, the cost (in terms of bandwidth or resource usage) of sending a temporal certificate chain is proportional to its length, which is in turn an (e.g. approximately linearly) increasing function of the time spent offline by a device, divided by the rate that the Root certificate is rotated. Thus, higher such costs are only incurred for devices that are offline for more than several Root certificate rotations. However, as the devices are offline for significant periods, the costs may be amortized over the entire time the device is in the field (including the time it was offline) thus significantly mitigating the impact of such incurred costs.

The device, in receipt of the temporal certificate chain, verifies the signature of each certificate in the chain using the (e.g. immediately) previous certificate in the chain. Thus, each certificate is authenticated using the previous certificate. The verification (authentication) may begin after the entire chain is received. Alternatively, the verification (authentication) may begin at least after the first certificate in the chain is received. Accordingly, all the Root certificates may be received by the electronic device prior to the electronic device authenticating a first one of the Root certificates, or all the Root certificates may be received by the electronic device prior to the electronic device authenticating some or all of the additional Root certificates. The signature of the first certificate in the chain is verified using the device's stored Root certificate. This may be the Root certificate which was indicated to the server to define the beginning of the chain. It is noted that the initial (original) Root certificate is typically provisioned in the device through another trusted method such as during the manufacturing process. However, as defined herein, Root certificates can be updated.

Once verified by the device, the device uses the last certificate in the chain to authenticate a Server certificate. In various embodiments, once the Server certificate is verified, the DTLS handshake (or similar operation) can complete. Subsequently, e.g. once the DTLS connection is established, the device may replace its Root certificate with the last certificate in the temporal certificate chain, thus updating the device to the most recent certificate.

Accordingly, a device may be offline for extended periods of time, but is still capable of catching up to the latest certificate on its first connection following the offline period. Certificates can therefore be updated or rotated independently of device offline time. Thus, certificates can be rotated or renewed arbitrarily often, which potentially improves security.

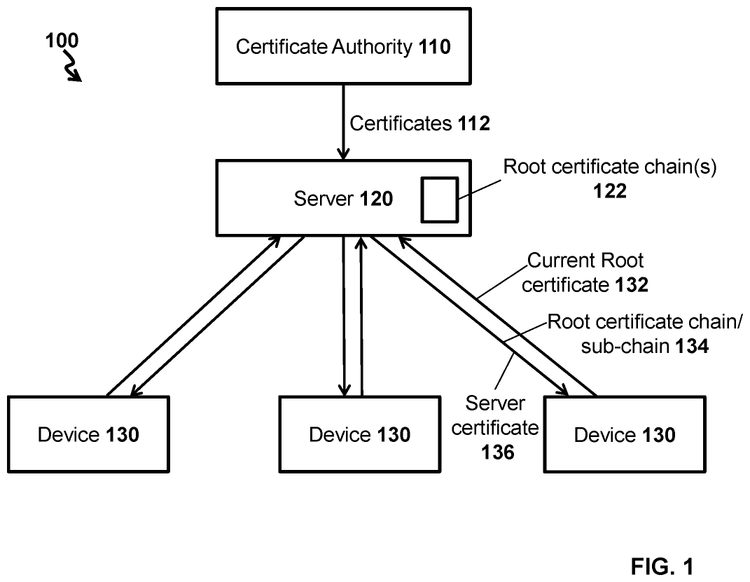

FIG. 1 illustrates a system 100 including a Certificate Authority (CA) 110, a server 120 (also referred to as an electronic server device) and one or more end devices 130 (also referred to as electronic devices). The CA itself may be a server or similar computerized resource. The CA 110 may in some cases be integrated with the server 120, although it is viewed herein as typically a separate device. The CA 110 provides certificates 112 to the server 120, for example periodically due to an ongoing certificate rotation or updating operation. The certificates 112 may include Root certificates. The certificates 112 may include server certificates which are able to be authenticated using Root certificates. The certificate changes (e.g. rotations) facilitate system security. The server 120 stores the certificates in memory with the certificates forming one or more certificate chains 122. The server 120 interacts with each device 130 to receive from a device an indication 132 of a current Root certificate held by the device 120, and to provide a Root certificate chain or sub-chain 134 to the device which includes all Root certificates (if any, and potentially multiple) between the current Root certificate held by the device and a Root certificate most recently received by the server 120 from the CA 110. In another embodiment, the server 120 may also provide a current server certificate 136 as part of the interaction, or subsequently. The interaction can be part of a handshake or other interaction in which the device authenticates the server. The handshake can be a DTLS handshake. The device authenticates the certificates in the chain and stores a most recent, authenticated certificate in memory for future use. Communication between the server 120 and the device 130 may be direct or indirect, e.g. via an access point, base station, wired or wireless network, or the like, or a combination thereof.

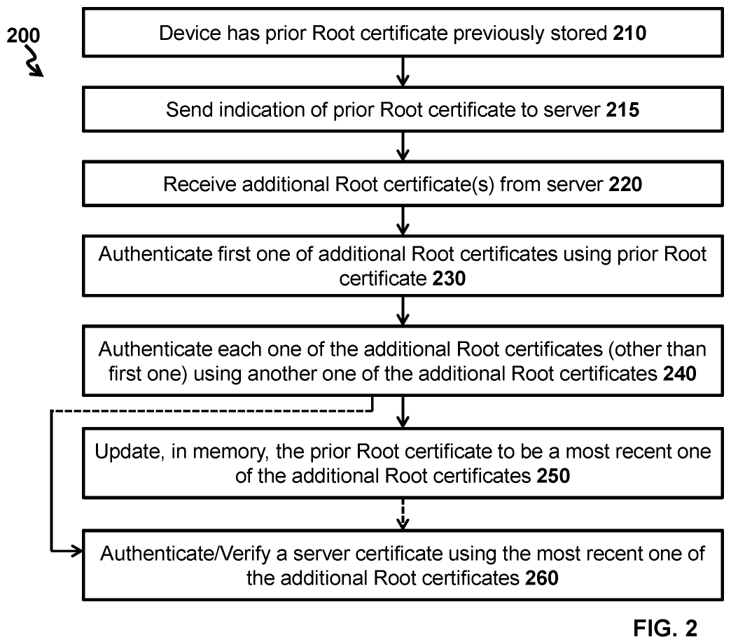

FIG. 2 illustrates operations 200 of an electronics device (e.g. an end device such as an IoT device) according to embodiments of the present disclosure. It is noted that FIG. 2 relates in particular to a scenario in which the device requires two or more Root certificates from the server. However, in other scenarios the device may require only one Root certificate, or the device may not require any Root certificates. The device has, previously stored 210 in memory, a prior Root certificate. The device may send 215 an indication of the prior Root certificate to a server via its communication interface. The indication may be an identifier of the Root certificate, or possibly the Root certificate itself or an identifiable portion thereof, or other information by which the Root certificate may be reliably identified. This sending may prompt the server to reply with additional Root certificates as described next, where the additional Root certificates are selected by the server, so as to form a contiguous chain with the prior Root certificate. The sending 215 allows the server to send only those Root certificates that are required, rather than all Root certificates, thereby reducing communications overhead.

The device thus receives 220, via its communication interface, two or more additional Root certificates from the server. The two or more additional Root certificates form a chain, and the two or more additional Root certificates plus the prior Root certificate form another (slightly larger) chain. The device further authenticates 230 a first one of the additional Root certificates using the prior Root certificate already stored in memory. This first one of the additional Root certificates and the prior Root certificate are contiguous in the chain, for example such that the first one of the additional Root certificates is signed using the prior Root certificate.

In addition to the authentication 230 of the first additional Root certificate, the device authenticates 240 each one of the additional Root certificates, other than the first additional Root certificate. Each authentication uses another one of the additional Root certificates. For example, the n^{th} additional Root certificate may be signed using the (n−1)^{st} additional Root certificate for n=1, 2, 3, . . . . In this case, the authentication 240 may authenticate the second additional Root certificate using the first additional Root certificate, authenticate the third additional Root certificate using the second additional Root certificate, and so on. That is, the n^{th} additional Root certificate is authenticated using the (n−1)^{st} additional Root certificate. This authenticating may be done for example by determining that the n^{th} additional Root certificate is signed using a private cryptographic key associated with (e.g. included as part of) the (n−1)^{st} additional Root certificate. The authentications 230 and 240 may be performed according to an ordering of the Root certificates, which may be indicated to the device by the server. The ordering indicates which Root certificate can be used to authenticate which other Root certificate in the chain.

After authenticating each one of the additional Root certificates, the prior Root certificate is updated 250 in memory to be a most recent one of the additional Root certificates. That is, if there are N authenticated Root certificates in the chain as provided by the server, with the n^{th} additional Root certificate signed using the (n−1)^{st} additional Root certificate for n=1, 2, . . . . N, then the prior Root certificate previously stored in memory is updated to be the N^{th} additional Root certificate. This updating may involve overwriting the prior Root certificate with the N^{th} additional Root certificate, for example. Thus, on the next iteration of the operations 200 illustrated in FIG. 2, the server can be prompted to send a chain of Root certificates beginning after this updated Root certificate rather than an older Root certificate, thereby shortening the chain as sent.

In some embodiments, the prior Root certificate is retained in memory until the updating 250. Thus, for example, the authentications of multiple intermediate Root certificates may not prompt the updating, but the authentication of the last Root certificate in a provided chain may prompt the updating. In other embodiments, the updating 250 may occur after authentication of each Root certificate in the chain.

The device may also authenticate 260 a server certificate which is indicative of an identity of the server, using the most recent one of the additional Root certificates. The server certificate can be signed using this most recent one of the additional Root certificates, for example. The device may authenticate a server certificate by determining that the server certificate is signed using a private key which is associated with the most recent one of the additional Root certificates. The authentication of a server certificate should be performed or finalized after the most recent one of the additional Root certificates is authenticated. The authentication may be part of a handshake, e.g. a DTLS handshake. Authentication 260 may be performed after either authentication 240 or updating 250.

The authentications 230 and 240 may be performed sequentially. In such embodiments, the authentication 240 proceeds after the authentication 230. Furthermore, in the authentication 240, each additional Root certificate is authenticated using another one of the additional Root certificates which has already been authenticated e.g. according to the authentication 230 or a previously executed portion of authentication 240. In this way, if any authentication fails, the remainder of the authentication process can be aborted.

The authentications 230 and 240 may be performed partially in parallel. In such embodiments, each additional Root certificate can be conditionally authenticated using another one of the additional Root certificates, even if that other one of the additional Root certificates is not yet authenticated or conditionally authenticated. A Root certificate can subsequently be declared authenticated if it is conditionally authenticated using another Root certificate, and if the other Root certificate itself has been declared authenticated. Thus, for example, each n^{th} additional Root certificate can be conditionally authenticated using the (n−1)^{st} additional Root certificate. Then, the first additional Root certificate is declared authentic because the prior Root certificate is authentic, the second additional Root certificate is declared authentic because the first additional Root certificate is authentic, and so on. In this way, some of the authentication processing operations can be performed in parallel. However, it is noted that the ultimate authentication is still sequential; the n^{th} additional Root certificate is only declared authentic after the (n−1)^{st} additional Root certificate is already declared authentic, for n=1, 2, . . . .

It is considered that the device may receive at least one invalid Root certificate. This may be a Root certificate which cannot be authenticated based on present information. In this case, the most recent Root certificate may be considered to be the last Root certificate which can be authenticated, and the invalid Root certificate can be considered to occur, according to the ordering, after this most recent one of the additional Root certificates. In this case, the device may determine that the at least one invalid Root certificate cannot be authenticated using the most recent one of the additional Root certificates. The device may subsequently discard the at least one invalid Root certificate. Server authentication may not be able to succeed in this case. However, the device can re-attempt the authentication process beginning with the updated, most recent Root certificate, which may be saved as the device's prior Root certificate. Some of the Root certificates may however have been authenticated, and the most recent of these may be stored in memory, thus updating the prior Root certificate.

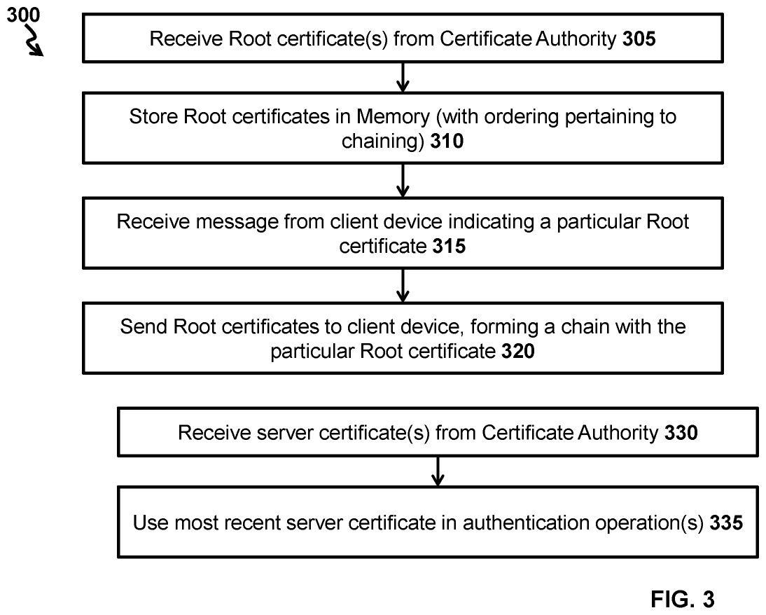

FIG. 3 illustrates operations 300 of an electronic device, e.g. a server, according to embodiments of the present disclosure. It is noted that FIG. 3 also relates in particular to a scenario in which a client device requires two or more Root certificates from the server. However, in other scenarios the client device may require only one Root certificate, or the device may not require any Root certificates. A plurality of Root certificates may be received 305 by the server from a certificate authority. The certificate authority provides the certificates for example periodically as they are rotated or replaced. The server operates to store 310 the received plurality of Root certificates in memory. An implicit or explicit indication of ordering of the Root certificates can also be received and stored in memory, if necessary, where the ordering pertains to chaining of the Root certificates. The plurality of Root certificates can indeed be organized into one or more chains, such that each Root certificate in the chain is signed using a private cryptographic key associated with (e.g. included in) a (e.g. immediately) previous one of the root certificates in the chain, according to the ordering. Authentication of a Root certificate may include determining or verifying such a signature. Chains pertaining to one or a plurality of end devices may be stored 310, as required.

The server further receives 315, from a client device, a message indicating a particular Root certificate. This particular Root certificate may be one of the stored Root certificates, or a Root certificate which is used to sign one of the stored Root certificates. For example, the particular Root certificate may have been originally provisioned into the client device, or else previously provided by the server or another similar server. The particular Root certificate may be a most recent Root certificate held by the client device. In response to the received message, the server sends 320, to the client device, two or more Root certificates from the stored plurality of Root certificates. These two or more Root certificates form a chain, and furthermore the two or more Root certificates form a chain along with the particular Root certificate as indicated by the client device. That is, a first Root certificate of the two or more Root certificates is signed using a private cryptographic key of the particular Root certificate, and each one of the two or more Root certificates other than the first Root certificate is signed using a private cryptographic key of another one of the two or more Root certificates. The most recent one of the two or more Root certificates, i.e. the last Root certificate in the chain, is a most up-to-date Root certificate. This last Root certificate may be usable by the client device to authenticate the server, for example, on the basis of a server certificate as described below. The particular Root certificate may be one of the plurality of Root certificates or it may immediately precede the plurality of Root certificates according to the ordering. The two or more Root certificates may immediately follow the particular Root certificate according to the ordering and may be a contiguous subset of the plurality of Root certificates according to the ordering.

The server may also send, along with the sending 320 of multiple Root certificates, an indication of the ordering of the Root certificates in the chain. The indication may be explicit, for example such that each Root certificate is numbered, or implicit, for example such that the Root certificates are included in the message according to the ordering. The ordering may be such that, when a first Root certificate is immediately prior to a second Root certificate in the ordering, the first Root certificate can be used directly to authenticate the second Root certificate, without use of other intervening Root certificates. The client device may use this indication in its authentication operations, for example to sequentially authenticate Root certificates according to the indicated ordering.

FIG. 3 further illustrates that the server may receive 330 server certificates from the CA, and may use 335 a most recently received server certificate in one or more authentication operations. The most recent server certificate may be signed with a particular private key, where the Root certificate currently in use (i.e. last Root certificate in the current chain) may include or indicate a public key corresponding to this particular private key. Using 335 a server certificate may involve the server sending the server certificate to the client device, for example along with or after sending the two or more Root certificates as in operation 320.

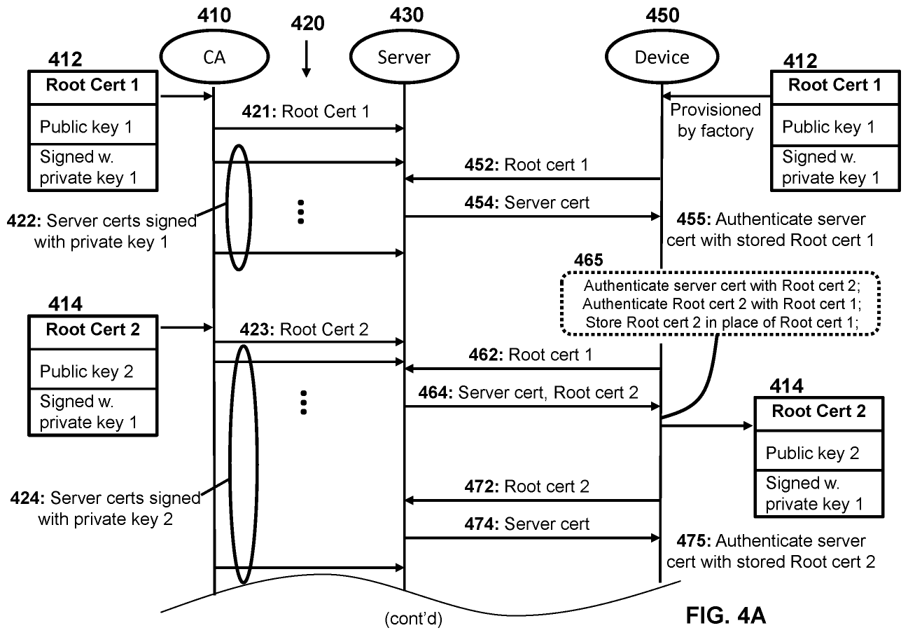

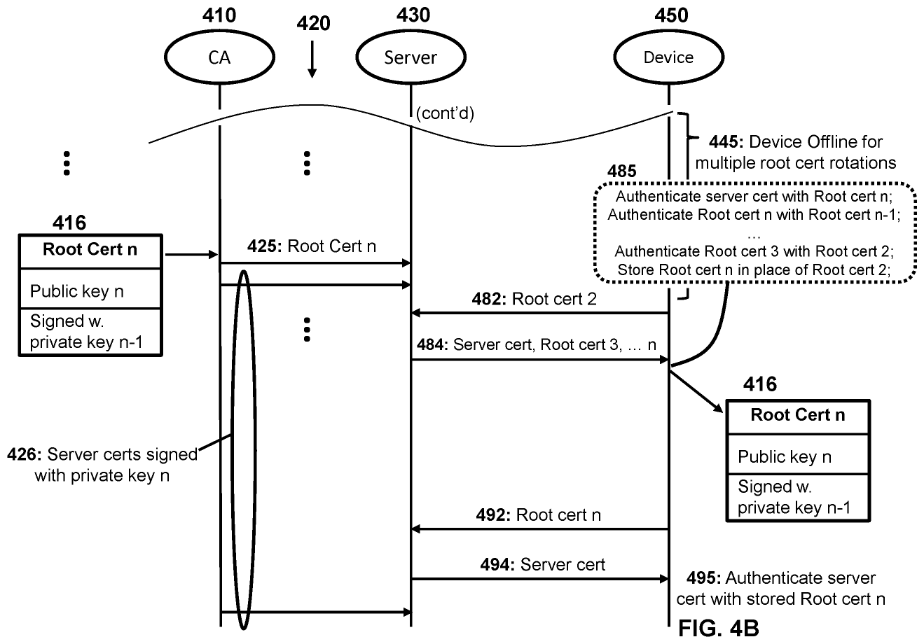

FIGS. 4A and 4B illustrate operations according to an example embodiment of the present disclosure. A certificate authority (CA) 410 utilizes different Root certificates over time according to a Root certificate rotation. Different Root certificates are thus used at different times, and each Root certificate is used for a given time period, for security purposes. Root certificates can be generated as-needed or retrieved from a secure memory location.

An initial one 412 of the Root certificates includes a first public key and is signed with a first private key. A second one 414 of the Root certificates corresponds to a second public key and is signed with the same first private key as the initial one 412 of the Root certificates. Similarly and thereafter, each n^{th} Root certificate 416 corresponds to an n^{th} public key and is signed with the (n−1)^{st} private key. Thus, cross-signing (forward signing) of Root certificates is employed. The initial Root certificate 412 is known at the CA 410 and also securely provided to a client device 450 for example at its time of manufacture.

The CA 410 provides 420 certificates, including server certificates and Root certificates, to a server 430. The server certificates are signed with the private key which corresponds to the public key of the Root certificate currently being utilized by the CA. Thus, for example, the CA may issue one or more server certificates 422 signed with the first private key during the time that the initial Root certificate 412 is utilized, may issue one or more server certificates 424 signed with the second private key during the time that the second Root certificate 414 is utilized, and may issue one or more server certificates 426 signed with the n^{th} private key during the time that the n^{th} Root certificate 416 is utilized.

As mentioned above, the CA 410 also provides 421, 423, 425 Root certificates to the server 430, for storage thereby. The CA may provide Root certificates at different points in time in response to Root certificate rotation. For example, the CA may provide 421 the first Root certificate prior to or along with providing 422 server certificates signed with the first private key, the CA may provide 423 the second Root certificate prior to or along with providing 424 server certificates signed with the second private key, and the CA may provide 425 the n^{th} Root certificate prior to or along with providing 426 server certificates signed with the n^{th} private key. The server 430 is informed explicitly or implicitly of the most recent Root certificate in use, as well as the ordering of Root certificates. The server may retain a record of all Root certificates provided, each Root certificate being signed by the previous Root certificate, so as to form a chain.

The server 430 interacts with a client device 450 as follows. When the client device 450 sends a message 452, 462, 472, 482, 492 which requires authentication of the server 430, the server 430 responds to the client device 450 with a message 454, 464, 474, 484, 494 which includes a server certificate and any required Root certificates. Each message 452, 462, 472, 482, 492 from the client device may be a “client hello” message, for example, or a similar DTLS message or a message according to another protocol. Each message 452, 462, 472, 482, 492 includes an indication of the most recent Root certificate held by the client device 450, which may be referred to herein as the prior Root certificate. This indication may be in a field (TLS extension) “trusted_ca_keys” of a DTLS message.

Initially, this most recent Root certificate held by the client device 450 and indicated in the message 452 is the initial one of the Root certificates 412 which is also utilized at the CA 410 and provided by the CA 410 to the server 430. As mentioned above, this initial one of the Root certificates may have been provisioned to the device 450 at the time of manufacture, or in another trusted manner. Subsequently, once the client device 450 has received and authenticated one or more Root certificates from the server 430, the most recent Root certificate (held by the client device in memory and indicated in messages 462, 472, 482, 492 to the server) can be updated to the most recent (according to ordering) Root certificate which has been authenticated by the client device.

The server 430, having received the message 452, determines, according to contents of the message 452, that the most recent Root certificate of the client device is the initial Root certificate 412. The server further determines in this case that the Root certificate, according to its own internal memory, which has been most recently provided by the CA 410 to the server 430, and which has been used for signing the server's current server certificate, is the same as the most recent Root certificate held by the client device. Therefore, the server provides its server certificate to the client in the message 454. The client device 450 is able to authenticate 455 the server certificate provided in the message 454 using its most recent Root certificate, and does so. Thus, the server certificate in this case is authenticated without any further Root certificates having to be received and authenticated at the client device 450. (Authentication 455 of the server certificate is as follows: the server certificate is signed with a first private key. The first Root certificate includes the first public key which can be used to authenticate this signature. Other server certificate authentications proceed similarly.)

The client device 450 subsequently sends another message 462, which is similar to the message 452. The message 462 also indicates that the most recent Root certificate held by the client device is the initial Root certificate 412. However, the message 462 is received after the CA 410 has begun utilizing the second Root certificate 414. The CA has also, as part of this utilization, provided this second Root certificate to the server 430 and has issued 424 a server certificate signed with the second private key (where the second Root certificate corresponds to the associated second public key).

The server 430, having received the message 462, determines, according to the message contents, that the most recent Root certificate held by the client device is (still) the initial Root certificate 412. The server further determines in this case that the Root certificate which has been most recently provided by the CA 410 to the server 430, and which has been used for signing the server's current server certificate, is a more recent Root certificate (i.e. the second Root certificate 414) than the most recent Root certificate held by the client device (i.e. the initial Root certificate 412). Therefore, the server provides its server certificate as well as the second Root certificate 414 to the client in the message 464. The client device is able to authenticate the second Root certificate 414 using the initial Root certificate 412, and does so. Once the second Root certificate is authenticated, the client device also stores this second Root certificate in memory as the most recent (prior) Root certificate. The client device 450 is also then able to authenticate the server certificate provided in the message 464 using its most recent Root certificate, i.e. the second Root certificate, and does so. The authentication of the server certificate may be performed before storing the Root certificate in memory. Alternatively, the authenticating of the server certificate may be performed after storing the Root certificate in memory. The two authentication actions and the storage action are shown in the action set 465. Thus, the server certificate in this case is authenticated after a single additional Root certificate has been received and authenticated.

The client device 450 subsequently sends another message 472, including an indication that the client device holds the second Root certificate 414 as its most recent Root certificate. This message is handled similarly to the message 452. The server 430, having received the message 472, determines according to the message contents that the most recent Root certificate of the client device is the second Root certificate 414. The server further determines that the Root certificate which has been most recently provided by the CA 410 to the server 430, and which has been used for signing the server's current server certificate, is the same as the most recent Root certificate held by the client device (i.e. also the second Root certificate 414). Therefore, the server provides its server certificate to the client in the message 474. The client device 450 is able to authenticate 475 the server certificate provided in the message 474 using its most recent Root certificate (Root certificate 2 414), and does so.

Subsequently to the operations of FIG. 4A, and as shown in FIG. 4B, at time 445, the client device 450 goes offline for a period of time, during which multiple Root certificates 3, . . . n (i.e. n>3) are rotated through at the CA 410. At each one of these rotations, the CA 410 provides, to the server, the corresponding Root certificate, as well as at least one server certificate, as described previously. Thus, the server receives and stores Root certificates 3, . . . n. Because the client device is offline, it falls behind on Root certificate updates, and embodiments of the present disclosure are implemented to bring the client device back up-to-date as described below.

After time 445, the client device 450 comes back online and sends a message 482, which is similar to the message 472. The message 482 indicates that the most recent Root certificate held by the client device is the second Root certificate 414. However, as mentioned above, at this time the CA 410 has already begun utilizing the n^{th} Root certificate 414. The CA has also provided the 3^{rd} to n^{th} 416 Root certificates to the server 430 and has issued 426 to the server 430 a server certificate signed with the n^{th} private key (where the n^{th} Root certificate corresponds to the associated n^{th} public key).

The server 430, having received the message 482, determines based on the message that the most recent Root certificate of the client device is (still) the second Root certificate 414. The server further determines in this case that the Root certificate which has been most recently provided by the CA 410 to the server 430, and which has been used for signing the server's current server certificate, is a more recent Root certificate (i.e. the n^{th} Root certificate 416) than the most recent Root certificate held by the client device (i.e. the second Root certificate 414). Therefore, the server provides its server certificate as well as all Root certificates after the second Root certificate 414 and up to and including the n^{th} Root certificate 416 (i.e. Root certificates 3, . . . n, n>3) to the client in the message 484. (The message 484, and similar messages 454, 464, 474, 494 may in some embodiments be broken into multiple smaller messages, if required.) Note that Root certificates 1 and 2 need not be provided in the message 484. The message 484 may further include an explicit or implicit indication of ordering of the multiple Root certificates, so that the device may know which Root certificate to use to authenticate a given Root certificate (e.g. the immediately prior Root certificate in the ordering).

The client device is able to authenticate the third Root certificate as provided in the message 484 using the already-held second Root certificate 414, and does so. Once the third Root certificate is authenticated, the client device is able to authenticate each subsequent Root certificate as provided in the message 484 using the previously (most recently) authenticated Root certificate. Therefore, the fourth Root certificate is authenticated using the third Root certificate, the fifth Root certificate (if present) is authenticated using the fourth Root certificate, and so on, up to the n^{th} Root certificate. Once the n^{th} Root certificate 416 is authenticated, the client device also stores this n^{th} Root certificate in memory as the most recent (prior) Root certificate. The client device 450 is also then able to authenticate the server certificate provided in the message 484 using its most recent Root certificate, i.e. the n^{th} Root certificate 416, and does so. The authentication and storage actions are shown as action set 485. Thus, the server certificate in this case is authenticated after multiple additional Root certificates forming a chain have been received and authenticated.

The client device 450 subsequently sends another message 492, including an indication that the client device holds the n^{th} Root certificate 414 as its most recent Root certificate. The server 430, having received the message 492, determines, based on contents of the message, that the most recent Root certificate of the client device is the n^{th} Root certificate 416. The server further determines that the Root certificate which has been most recently provided by the CA 410 to the server 430, and which has been used for signing the server's current server certificate, is the same as the most recent Root certificate held by the client device (i.e. also the n^{th} Root certificate 416). Therefore, the server provides its server certificate to the client in the message 494. The client device 450 is able to authenticate 495 the server certificate provided in the message 494 using its most recent Root certificate, and does so. Thus, due to the operations in response to receiving the message 482, the client device is back up-to-date with respect to Root certificates.

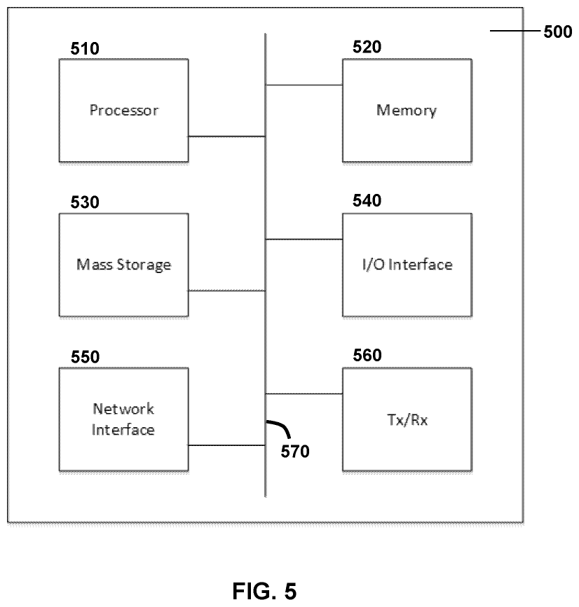

FIG. 5 is a schematic diagram of an electronic device 500 that may perform any or all of the steps of the above methods and features described herein, according to different embodiments of the present invention. For example, a user equipment (UE), server, base transceiver station (BTS), base station, wireless gateway or mobility router may be configured as the electronic device. Other examples include a client device such as a computer or other electronic device which is coupled to a network via wired, wireless, optical, cellular or non-cellular communication. It may be noted that the term “BTS” or “base station” refers to an evolved NodeB (eNB), New Radio (NR) or next generation NodeB (gNodeB or gNB), a radio access node, or another device in a wireless communication network infrastructure, such as a long term evolution (LTE) infrastructure, NR or 5G infrastructure, which performs or directs at least some aspects of wireless communication with wireless communication devices. The term “UE” refers to a device, such as a mobile device, machine-type-communication (MTC) device, machine-to-machine (M2M) equipment, Internet of Things (IOT) device, Internet of Vehicles (IoV) device or other device, which accesses the wireless communication network infrastructure via wireless communication with a base station. A UE, MTC, M2M, IoT or IoV device may alternatively access a network via another (e.g. non-cellular) medium, such as a wired, wireless or optical communication medium.

As shown, the device includes a processor 510, memory 520, non-transitory mass storage 530, I/O interface 540, network interface 550, and a transceiver 560, all of which are communicatively coupled via bi-directional bus 570. According to certain embodiments, any or all of the depicted elements may be utilized, or only a subset of the elements. Further, the device 500 may contain multiple instances of certain elements, such as multiple processors, memories, or transceivers. Also, elements of the hardware device may be directly coupled to other elements without the bi-directional bus. The processor 510 may be replaced with suitable other electronics, such as analog and/or digital electronics which are preconfigured to perform a given function. Electronics may include field programmable gate arrays, application specific integrated circuits, digital circuits, analog circuits, or the like, or a combination thereof. A processor or other electronics, or both, are collectively referred to as processing electronics. The network interface and the transceiver are examples of communication interfaces. A communication interface is a device which communicates with other devices either directly or indirectly (via intermediate devices) by transmitting and receiving signals via a wired, wireless or optical medium.

The memory 520 may include any type of non-transitory memory such as static random access memory (SRAM), dynamic random access memory (DRAM), synchronous DRAM (SDRAM), read-only memory (ROM), any combination of such, or the like. The mass storage element 530 may include any type of non-transitory storage device, such as a solid state drive, hard disk drive, a magnetic disk drive, an optical disk drive, USB drive, or any computer program product configured to store data and machine executable program code. According to certain embodiments, the memory 520 or mass storage 530 may have recorded thereon statements and instructions executable by the processor 510 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the methods described herein can be implemented as coded instructions in a computer program product. In other words, the computer program product is a computer-readable medium upon which software code is recorded to execute the methods when the computer program product is loaded into memory and executed on the microprocessor of the wireless communication device.

Acts associated with the methods described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the methods may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. An electronic device comprising:
a communication interface configured to communicate directly or indirectly with a server;
a memory configured to store a prior root certificate; and
processing electronics configured to:
send, to the server via the communication interface, an indication of the prior root certificate;
receive, from the server via the communication interface, a number of additional root certificates;
upon determination that the number of additional certificates is zero, the processing electronics further configured to authenticate the server using the prior root certificate, or
upon determination that the number of additional certificates is one or more, the processing electronics further configured to: authenticate the server using the prior root certificate and the one or more of the additional root certifications, and replace the prior root certificate with a most recent additional root certificate.

2. The electronic device of claim 1, wherein the additional root certificates are generated after the prior root certificate.

3. The electronic device of claim 1, wherein the electronic device determines an indication of ordering of the one or more additional root certificates.

4. The electronic device of claim 3, wherein the processing electronics further configured to:
authenticate a first one of the additional root certificates using the prior root certificate; and
after authenticating the first one of the additional root certificates: according to an ordering of the one or more additional root certificates, sequentially authenticating each one of the additional root certificates other than the first one of the additional root certificates using another one of the additional root certificates already authenticated.

5. The electronic device of claim 1, wherein authenticating of any one of the additional root certificates comprises determining that said one of the additional root certificates is signed with a private cryptographic key associated with another root certificate.

6. The electronic device of claim 1, further configured to authenticate a server certificate indicative of an identity of the server using the most recent one of the additional root certificates.

7. The electronic device of claim 3, wherein the electronic device receives at least one invalid root certificate which occur, according to the ordering, after the most recent one of the additional root certificates, and wherein the electronic device is further configured to:
determine that the at least one invalid root certificate cannot be authenticated using the most recent one of the additional root certificates; and
restart the process from the most recent one of the additional root certificates.

8. The electronic device of claim 1, wherein if the prior root certificate is different from the most recent one of the additional root certificates then one or more additional root certificates are received.

9. The electronic device of claim 1, wherein if the prior root certificate is the same as the most recent root certificates then zero additional root certificates are received.

10. An electronic server device comprising:
one or more communication interfaces configured to communicate directly or indirectly with a client device and with a certificate authority;
a memory; and
processing electronics configured to:
store, in the memory, a plurality of Root certificates along with an indication of ordering of the plurality of Root certificates, the plurality of Root certificates received from the certificate authority, each one of the plurality of Root certificates signed using a private cryptographic key associated with a previous one of the plurality of Root certificates according to the ordering; and
in response to the server device receiving, from the client device, at least one message including a message indicating a particular Root certificate: causing the server device to send, to the client device, two or more Root certificates of the plurality of Root certificates, wherein a first Root certificate of the two or more Root certificates is signed using a private cryptographic key of the particular Root certificate, and wherein each one of the two or more Root certificates other than the first Root certificate is signed using a private cryptographic key of another one of the two or more Root certificates.

11. The electronic server device of claim 10, wherein said previous one of the plurality of Root certificates is an immediately previous one of the plurality of Root certificates according to the ordering.

12. The electronic server device of claim 11, wherein:
the particular Root certificate is one of the plurality of Root certificates or immediately precedes the plurality of Root certificates according to the ordering; and
the two or more Root certificates immediately follow the particular Root certificate according to the ordering and are a contiguous subset of the plurality of Root certificates according to the ordering.

13. The electronic server device of claim 10, wherein the particular Root certificate is a most recent Root certificate held by the client device.

14. The electronic server device of claim 10, wherein the two or more Root certificates are sent to the client device, in one or more messages, in response to a same single message from the client device.

15. The electronic server device of claim 10, wherein the server implicitly or explicitly indicates, to the client device, the ordering among the two or more Root certificates.

16. A method comprising, by an electronic device having a prior Root certificate stored in memory:
in response to receiving, from a server, two or more additional Root certificates:
authenticating a first one of the additional Root certificates using the prior Root certificate;
after authenticating the first one of the additional Root certificates: sequentially authenticating each one of the additional Root certificates other than the first one of the additional Root certificates using another one of the additional Root certificates which is already authenticated; and
after authenticating each one of the additional Root certificates: updating, in the memory, the prior Root certificate to be a most recent one of the additional Root certificates.

17. The method of claim 16, further comprising receiving or determining an indication of ordering of the two or more additional Root certificates, and wherein said sequentially authenticating is performed according to said ordering.

18. The method of claim 16, further comprising authenticating a server certificate indicative of an identity of the server using the most recent one of the additional Root certificates.

19. The method of claim 16, further comprising, prior to receiving the two or more additional Root certificates, sending an indication of the prior Root certificate to the server.

20. A method comprising, by an electronic server device:
storing, in memory, a plurality of Root certificates along with an indication of ordering of the plurality of Root certificates, the plurality of Root certificates received from a certificate authority, each one of the plurality of Root certificates signed using a private cryptographic key associated with a previous one of the plurality of Root certificates according to the ordering; and
in response to the server device receiving, from a client device, at least one message including a message indicating a particular Root certificate: sending, to the client device, two or more Root certificates of the plurality of Root certificates, wherein a first Root certificate of the two or more Root certificates is signed using a private cryptographic key of the particular Root certificate, and wherein each one of the two or more Root certificates other than the first Root certificate is signed using a private cryptographic key of another one of the two or more Root certificates.

21. The method of claim 20, wherein:
said previous one of the plurality of Root certificates is an immediately previous one of the plurality of Root certificates according to the ordering;
the particular Root certificate is a most recent Root certificate held by the client device; and
the server implicitly or explicitly indicates, to the client device, the ordering among the two or more Root certificates.
